(19) United States
(12) Patent Application Publication
(10) Pub. No.: US 2026/0007966 A1
(43) Pub. Date: Jan. 8, 2026

(54) GAME INTERACTION METHOD AND APPARATUS, COMPUTER DEVICE, COMPUTER-READABLE STORAGE MEDIUM, AND COMPUTER PROGRAM PRODUCT

(71) Applicant: Tencent Technology (Shenzhen) Company Limited, Shenzhen (CN)

(72) Inventor: Tao WANG, Shenzhen (CN)

(73) Assignee: Tencent Technology (Shenzhen) Company Limited, Shenzhen (CN)

(21) Appl. No.: 19/324,563

(22) Filed: Sep. 10, 2025

Related U.S. Application Data
(63) Continuation of application No. PCT/CN2024/115238, filed on Aug. 28, 2024.

(30) Foreign Application Priority Data
Oct. 30, 2023 (CN) 202311431308.7

(51) Int. Cl. A63F 13/53; G06T 15/04

(52) U.S. Cl. CPC A63F 13/53; G06T 15/04; G06T 2210/16

(57) ABSTRACT

A game interaction method, performed by a computer device, includes displaying a game page including a depiction of an original garment; obtaining a first keyword and original garment information of the original garment in response to a first trigger operation for a generation function, the original garment information including at least one of a first diffuse map, a first normal map, and a first material map, wherein the first diffuse map indicates a style and a color of the original garment, the first normal map indicates a visual effect of the original garment, and the first material map indicates a material of the original garment; generating a target garment, based on the original garment information, that matches the first keyword, and displaying the target garment; and including the target garment in a game interaction.

### CROSS-REFERENCE TO RELATED APPLICATIONS

This application is a continuation application of International Application No. PCT/CN2024/115238 filed on Aug. 28, 2024, which claims priority to Chinese Patent Application No. 202311431308.7 filed with the China National Intellectual Property Administration on Oct. 30, 2023, the disclosures of each being incorporated by reference herein in their entireties.

### FIELD

Embodiments of this application belong to the field of computer technologies, and relate, but are not limited, to a game interaction method and apparatus, a computer device, a computer-readable storage medium, and a computer program product.

### BACKGROUND

With continuous development of computer technologies, a growing number of users play games as an entertainment manner. To make a game more interesting, different garments are usually provided in the game for a user to perform garment replacement.

A player can select a garment only from garments provided in a game, so that a range of selecting a garment by the player is relatively small. The garment provided in the game may not be a garment expected by the player. A game interaction method limits depth and efficiency of game interaction of the player. The player has to search another way to further interact in a game process, to select a garment highly matching the player. A large waste of computing resources will be caused.

No effective solutions are provided to expand a deep and efficient interaction manner in a game by means of resource intensity.

### SUMMARY

According to an aspect of the disclosure, a game interaction method, performed by a computer device, includes displaying a game page including a depiction of an original garment; obtaining a first keyword and original garment information of the original garment in response to a first trigger operation for a generation function, the original garment information including at least one of a first diffuse map, a first normal map, and a first material map, wherein the first diffuse map indicates a style and a color of the original garment, the first normal map indicates a visual effect of the original garment, and the first material map indicates a material of the original garment; generating a target garment, based on the original garment information, that matches the first keyword, and displaying the target garment; and including the target garment in a game interaction.

According to an aspect of the disclosure, a game interaction apparatus includes, at least one memory configured to store computer program code; and at least one processor configured to read the program code and operate as instructed by the program code, the program code including: first display code configured to cause at least one of the at least one processor to display a game page including a depiction of an original garment; obtaining code configured to cause at least one of the at least one processor to obtain a first keyword and original garment information of the original garment in response to a first trigger operation for a generation function, the original garment information including at least one of a first diffuse map, a first normal map, and a first material map, wherein the first diffuse map indicates a style and a color of the original garment, the first normal map indicates a visual effect of the original garment, and the first material map indicates a material of the original garment; second display code configured to cause at least one of the at least one processor to generate a target garment, based on the original garment information, that matches the first keyword, and display the target garment; and interaction code configured to cause at least one of the at least one processor to include the target garment in a game interaction.

According to an aspect of the disclosure, a non-transitory computer-readable storage medium, storing computer code which, when executed by at least one processor, causes the at least one processor to at least display a game page including a depiction of an original garment; obtain a first keyword and original garment information of the original garment in response to a first trigger operation for a generation function, the original garment information including at least one of a first diffuse map, a first normal map, and a first material map, wherein the first diffuse map indicates a style and a color of the original garment, the first normal map indicates a visual effect of the original garment, and the first material map indicates a material of the original garment; generate a target garment, based on the original garment information, that matches the first keyword, and display the target garment; and include the target garment in a game interaction.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of some embodiments of a game interaction method according to some embodiments.

FIG. 2 is a flowchart of a game interaction method according to some embodiments.

FIG. 3 is a schematic diagram of display of a game page according to some embodiments.

FIG. 4 is a schematic diagram of display of another game page according to some embodiments.

FIG. 5 is a schematic diagram of display of still another game page according to some embodiments.

FIG. 6 is a diagram of a process of obtaining a diffuse map model according to some embodiments.

FIG. 7 is a diagram of a process of obtaining a first text noise feature and a first

image noise feature according to some embodiments.

FIG. 8 is a diagram of a process of obtaining a second image feature according to some embodiments.

FIG. 9 is a schematic diagram of display of another game page according to some embodiments.

FIG. 10 is a flowchart of a game interaction method according to some embodiments.

FIG. 11 is a schematic structural diagram of a game interaction apparatus according to some embodiments.

FIG. 12 is a schematic structural diagram of a terminal device according to some embodiments.

FIG. 13 is a schematic structural diagram of a server according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

The terms “first”, “second”, and the like in some embodiments are intended to distinguish similar objects but do not necessarily indicate a specific order or sequence. The terms used in such a way are interchanged in proper circumstances, so that some embodiments described herein can be implemented in other orders than the order illustrated or described herein.

The terms “module [s]” or “unit [s]” may refer to hardware logic, a processor or processors executing computer software code, or a combination of both. The “modules” or “units” may also be implemented in software stored in a memory of a computer or a non-transitory computer-readable medium, where the instructions of each unit are executable by a processor to thereby cause the processor to perform the respective operations of the corresponding module or unit.

Each module or unit may exist respectively or be combined into one or more units. Some modules or units may be further split into multiple smaller function subunits, thereby implementing the same operations without affecting the technical effects of some embodiments. The modules or units are divided based on logical functions. In actual applications, a function of one module or unit may be realized by multiple modules or units, or functions of multiple modules or units may be realized by one module or unit. In some embodiments, the apparatus may further include other modules or units. In actual applications, these functions may also be realized cooperatively by the other modules or units, and may be realized cooperatively by multiple modules or units.

Before a game interaction method according to some embodiments is described, the abbreviations and key terms involved in some embodiments are first defined.
(1) Artificial intelligence (AI) involves a theory, a method, a technology, and an application system that use a digital computer or a machine controlled by the digital computer to simulate, extend, and expand intelligence, perceive an environment, obtain knowledge, and use knowledge to obtain an optimal result. AI is a comprehensive technology in computer science, and attempts to understand essence of intelligence and produce a new intelligent machine that can react in a manner similar to human intelligence. AI is to research design principles and implementation methods of various intelligent machines, so that the machines have functions of perception, reasoning, and decision-making. AI technology is a comprehensive discipline and covers a wide range of fields, and includes both technologies at the hardware level and technologies at the software level. Basic AI technologies may include a sensor, a dedicated AI chip, cloud computing, distributed storage, a big data processing technology, a pre-training model technology, an operating/interaction system, electromechanical integration, and the like. The pre-training model is also referred to as a large model or a basic model. After fine tuning, the pre-training model may be widely applied to downstream tasks in various large directions of AI. AI software technologies may include several major directions, such as a computer vision technology, a speech processing technology, a natural language processing (NLP) technology, and machine learning (ML)/deep learning.
(2) NLP is an important direction in the field of computer science and the field of AI. NLP studies various theories and methods that can implement effective communication between people and computers by using natural languages. NLP involves natural languages, used by people in daily life. NLP is closely related to linguistic studies while also encompassing computer science and mathematics. As a key technology for model training in the field of AI, the pre-training model has evolved from a large language model in the field of NLP. After fine-tuning, the large language model may be widely applied to downstream tasks. The NLP technologies may include technologies such as text processing, semantic understanding, machine translation, robot question-answering, and knowledge graph.
(3) ML is a multi-field interdiscipline, and relates to a plurality of disciplines such as the probability theory, statistics, the approximation theory, convex analysis, and the algorithm complexity theory. ML involves studying how a computer simulates or implements a human learning behavior to acquire new knowledge or skills, and reorganize an existing knowledge structure, to keep improving its performance. ML is a core of AI, is a fundamental way to make a computer intelligent, and is applied in various fields of AI. ML and deep learning may include technologies such as an artificial neural network, a confidence network, reinforcement learning, transfer learning, inductive learning, and tutorial learning. The pre-training model is a latest development result of deep learning, and combines the foregoing technologies.
(4) A virtual scene refers to a scene provided (or displayed) by an application while running on a terminal device. The virtual scene is a created scene in which virtual objects operate. The virtual scene may be a two-dimensional virtual scene, a 2.5-dimensional virtual scene, a three-dimensional virtual scene, or the like. The virtual scene may be a simulated scene of the real world, may be a semi-simulated scene of the real world, or may be a purely fictional scene. By way of example, the virtual scene involved in some embodiments may be a three-dimensional virtual scene.
(5) A virtual object refers to a movable object in a virtual scene. The movable object may be a virtual person, a virtual animal, a cartoon person, or the like. A player may control the virtual object by using a peripheral component or by clicking/tapping and touching a display screen. Each virtual object has a shape and a volume in the virtual scene, and occupies a part of space in the virtual scene. By way of example, when the virtual scene is a three-dimensional virtual scene, the virtual object is a three-dimensional model created based on a skeletal animation technology.
(6) A text feature is a string of digital code. Since a computer device cannot identify text, some model tools may convert text into particular digital code. The computer device may identify and utilize the digital code for subsequent picture generation.
(7) An image feature is a string of digital code. Since a computer device cannot identify a pixel image, some model tools may convert a picture into particular digital code. The computer device may identify and utilize the digital code for subsequent picture generation.

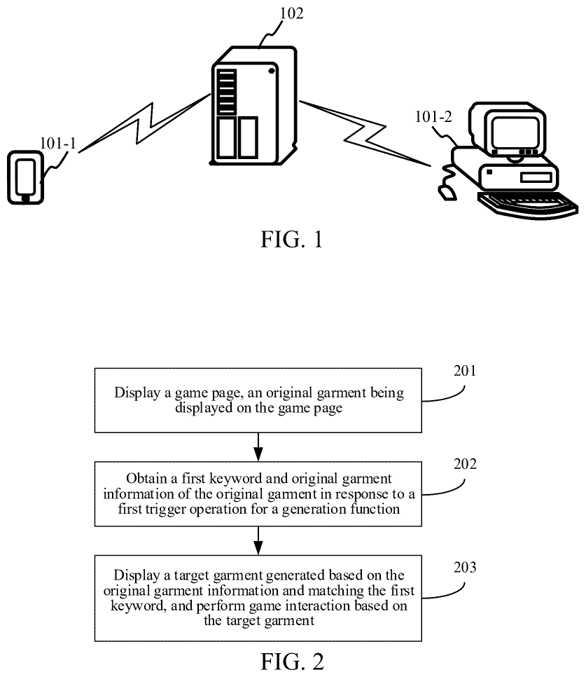

FIG. 1 is a schematic diagram of some embodiments of a game interaction method according to some embodiments. As shown in FIG. 1, some embodiments may include a terminal device (a terminal device 100-1 or a terminal device 100-2 illustrated in FIG. 1) and a server 102. A game client capable of providing a virtual scene is installed and run in the terminal device. The terminal device is configured to perform the game interaction method according to some embodiments.

By way of example, the game client capable of providing the virtual scene may be a third-person shooting (TPS) game, a first-person shooting (FPS) game, a multiplayer online battle arena (MOBA) game, a multiplayer shooting survival game, a massive multiplayer online role-playing game (MMO), an action role playing game (ARPG), a virtual reality (VR) client, an augmented reality (AR) client, a three-dimensional mapping application, a map simulation program, a social client, an interactive entertainment client, or the like.

The server 102 is configured to provide a back-end service for the game client capable of providing the virtual scene, where the game client is installed in the terminal device. In some embodiments, the server 102 takes on primary computing work, and the terminal device takes on secondary computing work. Collaborative computing is performed between the server 102 and the terminal device by using a distributed computing architecture.

By way of example, the terminal device may be any electronic device product that may perform human-computer interaction with a user in one or more manners such as a keyboard, a touchpad, a remote control, voice interaction, or a handwriting device. For example, the terminal device may be a smartphone, a tablet, a laptop, a desktop, a smart speaker, a smartwatch, a personal computer (PC), a mobile phone, a personal digital assistant (PDA), a wearable device, a pocket PC (PPC), a smart on-board unit, a smart television, or the like.

The terminal device may refer to one of a plurality of terminal devices. In some embodiments, only the terminal device is used as an example for description. A person skilled in the art may learn that there may be more or fewer terminal devices. For example, there is only one terminal device, or there are dozens or hundreds of terminal devices, or more terminal devices. A quantity of terminal devices and a device type are not limited in some embodiments.

The server 102 may be one server, a server cluster formed by a plurality of servers, or any one of a cloud computing center or a virtualization center. However, the disclosure is not limited thereto. The server 102 and the terminal device are directly or indirectly communicatively connected in a wired or wireless communication manner. The server 102 has a data receiving function, a data processing function, and a data transmitting function. The server 102 may have other functions. However, the disclosure is not limited thereto.

A person skilled in the art can understand that the terminal device and the server 102 are only examples, and other terminal devices or servers that are applicable to this application are also to be included in the scope of protection of some embodiments, and are included herein by reference.

Some embodiments provide a game interaction method. The method is applicable to some embodiments shown in FIG. 1. By taking a flowchart of a game interaction method shown in FIG. 2 as an example, the method may be performed by the terminal device in FIG. 1. As shown in FIG. 2, the method includes the following operation 201 to operation 203.

In operation 201, a game page is displayed. An original garment is displayed on the game page.

In some embodiments, a game client is installed and run in a terminal device. The game client may be a client of any game. However, the disclosure is not limited thereto. Related information of the game client is displayed on a display interface of the terminal device. The related information of the game client may be a name of the game client, an icon of the game client, or other information that can uniquely represent the game client. The related information of the game client is not limited in some embodiments.

When the game object desires to run the game client, the game object selects the related information of the game client. The terminal device receives a selection operation for the related information of the game client, starts the game client, and displays a game home page. A virtual object is displayed on the game home page. The virtual object is a virtual object controlled by the game object in the game client. The game object is a user of the terminal device. That the game object selects the related information of the game client may be that the game object clicks/taps the related information of the game client, or the game object may select the related information of the game client in another manner. However, the disclosure is not limited thereto.

In some embodiments, the virtual object displayed in the game home page wears an original garment. The game home page may further display a garment generation control. The garment generation control is configured to generate a garment. When the game object desires to generate a new garment for the virtual object, the game object selects the garment generation control. The terminal device receives a trigger operation for the garment generation control, and displays the game page. The original garment is displayed on the game page.

Displaying the original garment on the game page means that the virtual object displayed on the game page wears the original garment. That the game object selects the garment generation control may be that the game object clicks/taps the garment generation control. The game object may select the garment generation control in another manner. However, the disclosure is not limited thereto.

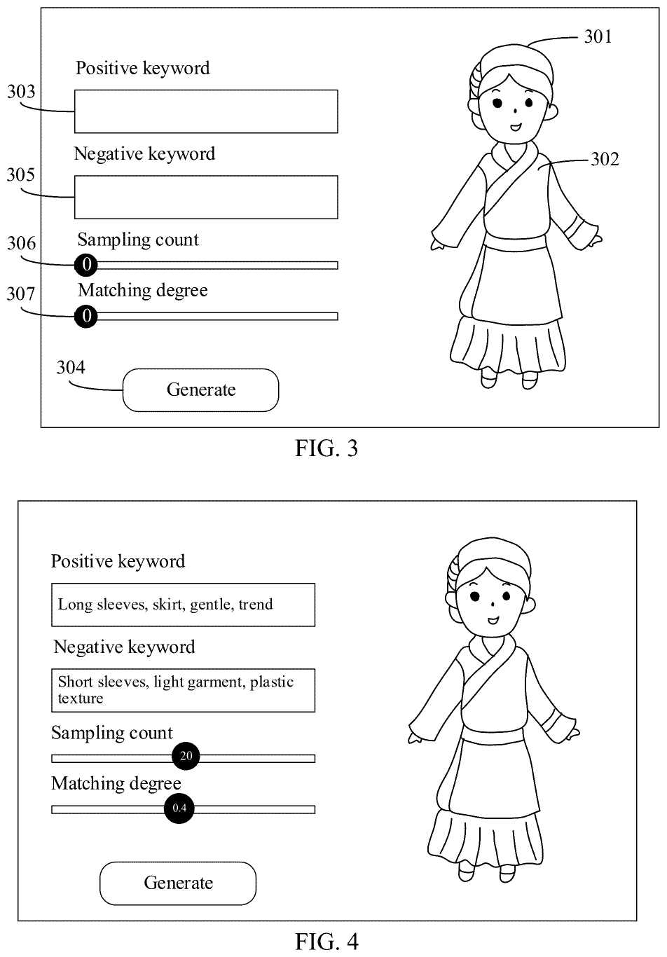

FIG. 3 is a schematic diagram of display of a game page according to some embodiments. A virtual object 301 is displayed on a game page shown in FIG. 3. The virtual object 301 wears an original garment 302.

In operation 202, a first keyword and original garment information of the original garment are obtained in response to a first trigger operation for a generation function.

The original garment information includes at least one of a first diffuse map, a first normal map, and a first material map. The first diffuse map is configured for indicating a style and a color of the original garment. The first normal map is configured for indicating a visual effect of the original garment. The first material map is configured for indicating a material of the original garment. The material of the original garment may be cotton, linen, silk, leather, or the like.

In some embodiments, the game page further displays a first keyword region. The first keyword region is configured for obtaining a first keyword. The first keyword region is, for example, a first keyword region 303 in FIG. 3. A first keyword obtained in the first keyword region 303 may be a positive keyword. The positive keyword is a positive descriptive word for describing a final target garment to be generated by the game object. The positive keyword provides information serving as a reference for calculating a style of the final target garment.

When the game object desires to generate a new garment, the game object inputs text content in the first keyword region, so that the text content input by the game object is displayed in the first keyword region on the game page. In some embodiments, the game object may input a long text (for example, an original input text having a text length greater than a length threshold) in the first keyword region. The terminal device may perform text recognition on the long text to obtain at least one keyword in the long text, thereby obtaining a first keyword. The recognized first keyword is displayed in the first keyword region. In some embodiments, the game object may directly input at least one keyword in the first keyword region. The terminal device may use the at least one keyword input by the game object as the first keyword, which is displayed in the first keyword region.

In some embodiments, the game page further displays a generation control, for example, the generation control 304 in FIG. 3. If the game object selects the generation control, the terminal device receives a first trigger operation for the generation function, and the terminal device obtains the first keyword and the original garment information of the original garment in response to the first trigger operation for the generation function.

In some embodiments, the process of obtaining, by the terminal device, the first keyword includes: obtaining text content displayed in a first keyword region and using that text content as the first keyword. The process of obtaining, by the terminal device, original garment information of the original garment includes: generating, by the terminal device, a garment information obtaining request that carries an identifier of the original garment. The identifier of the original garment may be a name of the original garment, a serial number of the original garment, or another identifier that can uniquely indicate the original garment. However, the disclosure is not limited thereto. The terminal device transmits the garment information obtaining request to a garment information server. The garment information server receives the garment information obtaining request transmitted by the terminal device and parses the request to obtain the identifier of the original garment. The garment information server stores garment information of each garment and a corresponding relationship between an identifier of each garment and garment information of the corresponding garment. The garment information server may determine original garment information of the original garment according to the identifier of the original garment and the stored corresponding relationship. The garment information server then transmits the original garment information of the original garment to the terminal device, so that the terminal device obtains the original garment information of the original garment.

In operation 203, a target garment generated based on the original garment information and matching the first keyword is displayed, and game interaction is performed based on the target garment.

In some embodiments, before a target garment that is generated based on the original garment information and matches the first keyword is displayed, the target garment matching the first keyword may be first generated according to the original garment information.

A second keyword, a target sampling count, and a target matching degree may further be obtained in response to a second trigger operation for the generation function. The second keyword is a keyword not matching the target garment. The target sampling count is a count of repetitions of a sampling process of obtaining target garment information of the target garment. The target matching degree is a matching degree between the target garment and the first keyword. The target garment information includes at least one of a second diffuse map, a second normal map, and a second material map. The second diffuse map is configured for indicating a style and a color of the target garment. The second normal map is configured for indicating a visual effect of the target garment. The second material map is configured for indicating a material of the target garment.

The game page may further display a second keyword region, a sampling count region, and a matching degree region. The second keyword region is configured for obtaining a second keyword. The sampling count region is configured for obtaining a target sampling count. The matching degree region is configured for obtaining a target matching degree. The regions are, for example, a second keyword region 305, a sampling count region 306, and a matching degree region 307 shown in FIG. 3. The second keyword obtained in the second keyword region 305 may be a negative keyword. The negative keyword is a negative descriptive word for describing a final target garment not to be generated by the game object. The negative keyword provides information not serving as a reference for calculating a style of the final target garment.

The game object may input text content in the second keyword region, determine a target sampling count by swiping a control in the sampling count region, and determine a target matching degree by swiping a control in the matching degree region. The input text content is displayed in the second keyword region of the game page, the target sampling count is displayed in the sampling count region, and the target matching degree is displayed in the matching degree region. FIG. 4 is a schematic diagram of display of another game page according to some embodiments. Text content displayed in a first keyword region of the game page shown in FIG. 4 is “Long sleeves, skirt, gentle, trend”. Text content displayed in a second keyword region is “Short sleeves, light garment, plastic texture”. A target sampling count displayed in a sampling count region is “20”. A target matching degree displayed in a matching degree region is “0.4”.

The process of obtaining a second keyword in response to a second trigger operation for the generation function includes: obtaining text content displayed in the second keyword region and using the text content displayed in the second keyword region as the second keyword. A keyword corresponding to text content displayed in the second keyword region may be used as the second keyword. The process of obtaining a target sampling count includes: using a sampling count displayed in the sampling count region as the target sampling count. The process of obtaining a target matching degree includes: using a matching degree displayed in the matching degree region as the target matching degree.

The process of generating, according to the original garment information, a target garment matching the first keyword includes: generating the target garment by sampling based on the target sampling count according to the first keyword, the second keyword, the target matching degree, and the original garment information. A matching degree between the target garment and the first keyword is the target matching degree, and the target garment does not match the second keyword.

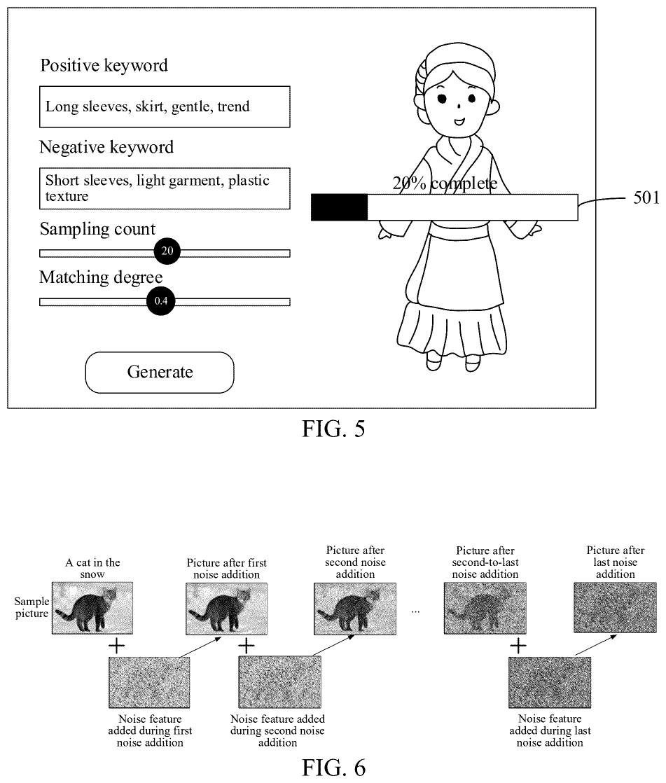

In some embodiments, a generation progress bar may further be displayed on the game page in response to a trigger operation for the generation function. The generation progress bar is configured for indicating a generation progress of the target garment. FIG. 5 is a schematic diagram of display of still another game page according to some embodiments. A generation progress bar 501 is displayed on the game page shown in FIG. 5. As indicated by the displayed generation progress bar, the target garment is currently being generated and is 20% complete.

In some embodiments, the process of generating the target garment by sampling based on the target sampling count according to the first keyword, the second keyword, the target matching degree, and the original garment information includes: obtaining target garment information of the target garment by sampling based on the target sampling count according to the first keyword, the second keyword, the target matching degree, and the original garment information; and generating the target garment according to the target garment information.

In some embodiments, the original garment information includes a first diffuse map, and the target garment information includes a second diffuse map. The second diffuse map of the target garment may be obtained by sampling based on the target sampling count according to the first keyword, the second keyword, the target matching degree, and the first diffuse map. The original garment information includes a first normal map, and the target garment information includes a second normal map. The second normal map of the target garment is obtained by sampling based on the target sampling count according to the first keyword, the second keyword, the target matching degree, and the first normal map. The original garment information includes a first material map, and the target garment information includes a second material map. The second material map of the target garment is obtained by sampling based on the target sampling count according to the first keyword, the second keyword, the target matching degree, and the first material map.

The process of obtaining the second diffuse map of the target garment by sampling based on the target sampling count according to the first keyword, the second keyword, the target matching degree, and the first diffuse map, the process of obtaining the second normal map of the target garment by sampling based on the target sampling count according to the first keyword, the second keyword, the target matching degree, and the first normal map, and the process of obtaining the second material map of the target garment by sampling based on the target sampling count according to the first keyword, the second keyword, the target matching degree, and the first material map are similar. In some embodiments, only the process of obtaining the second diffuse map of the target garment by sampling based on the target sampling count according to the first keyword, the second keyword, the target matching degree, and the first diffuse map is used as an example for description.

In some embodiments, the process of obtaining the second diffuse map of the target garment by sampling based on the target sampling count according to the first keyword, the second keyword, the target matching degree, and the first diffuse map includes: obtaining a target text feature according to the first keyword and the second keyword, the target text feature being configured for representing the first keyword and the second keyword; obtaining a first image feature according to the first diffuse map, the first image feature being configured for representing the first diffuse map; obtaining a second image feature by sampling based on the target sampling count according to the target text feature, the first image feature, and the target matching degree, the second image feature being configured for representing the second diffuse map; and decoding the second image feature, to obtain the second diffuse map.

The manner of obtaining a target text feature according to the first keyword and the second keyword is not limited in some embodiments. The process of obtaining a target text feature according to the first keyword and the second keyword includes: obtaining a first text feature for representing the first keyword; obtaining a second text feature for representing the second keyword; and determining the target text feature according to the first text feature and the second text feature.

The process of obtaining a first text feature for representing the first keyword is similar to the process of obtaining a second text feature for representing the second keyword. In some embodiments, only the process of obtaining a first text feature for representing the first keyword is used as an example for description. The process of obtaining a first text feature for representing the first keyword includes: inputting the first keyword to a contrastive language-image pre-training (CLIP) encoder, and using content output by the CLIP encoder as the first text feature. The CLIP encoder is a pre-training model for contrasting texts with pictures. A function of the CLIP encoder is to associate the pictures with the texts. In some embodiments, texts are converted into text features by using a text encoder of the CLIP encoder.

In some embodiments, the first text feature and the second text feature have a same dimensionality. The process of obtaining a target text feature according to the first text feature and the second text feature includes: adding values of the first text feature and the second text feature at corresponding positions, to obtain the target text feature; or, multiplying values of the first text feature and the second text feature at corresponding positions, to obtain the target text feature; or, determining an average of values of the first text feature and the second text feature at corresponding positions, and obtaining the target text feature according to the average of the values of the first text feature and the second text feature at the corresponding positions.

By way of example, the first text feature is (A, B, C), the second text feature is (D, E, F), and the target text feature is (A+D, B+E, C+F).

The first text feature is (A, B, C), the second text feature is (D, E, F), and the target text feature is (AD, BE, CF).

The first text feature is (A, B, C), the second text feature is (D, E, F), and the target text feature is

$$( \frac{A + D}{2} , \frac{B + E}{2} , \frac{C + F}{2} ) .$$

In some embodiments, if the dimensionality of the first text feature is greater than the dimensionality of the second text feature, the dimensionality of the second text feature is increased, to obtain a dimensionality-increased second text feature. The dimensionality-increased second text feature and the first text feature have the same dimensionality. The target text feature is obtained according to the first text feature and the dimensionality-increased second text feature. The process of obtaining the target text feature according to the first text feature and the dimensionality-increased second text feature is similar to the foregoing process of obtaining the target text feature according to the first text feature and the second text feature.

In some embodiments, if the dimensionality of the first text feature is less than the dimensionality of the second text feature, the dimensionality of the first text feature is increased, to obtain a dimensionality-increased first text feature. The dimensionality-increased first text feature and the second text feature have the same dimensionality. The target text feature is obtained according to the dimensionality-increased first text feature and the second text feature. The process of obtaining the target text feature according to the dimensionality-increased first text feature and the second text feature is similar to the foregoing process of obtaining the target text feature according to the first text feature and the second text feature.

In some embodiments, the target text feature may further be obtained according to the first text feature and the second text feature in the following manner. The manner includes: inputting the first text feature and the second text feature to a CLIP encoder, and using content output by the CLIP encoder as the target text feature.

In some embodiments, the process of obtaining a first image feature according to the first diffuse map includes: resizing the first diffuse map, reducing dimensionality, and adding a random noise by using a variational autoencoder (VAE), to obtain a noise image; and obtaining the first image feature according to the noise image. The VAE includes an encoder and a decoder. The encoder is configured to convert a picture into an image feature in a potential space, and the decoder is configured to convert the image feature in the potential space into the picture.

By way of example, the first diffuse map is 512×512 pixels after resizing and is represented as 64×64 after dimensionality reduction.

In some embodiments, the process of obtaining a second image feature by sampling based on the target sampling count according to the target text feature, the first image feature, and the target matching degree includes: obtaining a first text noise feature and a first image noise feature according to the target text feature, the first image feature, and a first value for a first sampling in the target sampling count, and then determining a first reference feature according to the first text noise feature, the first image noise feature, the target matching degree, and the first image feature, the first reference feature being a feature obtained by denoising the first image feature during the first sampling, the first text noise feature and the first image noise feature matching the target text feature and the first image feature respectively, and the first value being configured for representing the first sampling; obtaining a second text noise feature and a second image noise feature according to the target text feature, the reference feature, and a second value for a non-first sampling in the target sampling count; determining a second reference feature according to the second text noise feature, the second image noise feature, the target matching degree, and the reference feature, the second reference feature being a feature obtained by denoising the reference feature during the non-first sampling, the second text noise feature and the second image noise feature matching the target text feature and the reference feature respectively, the reference feature being a feature obtained by a previous sampling to the non-first sampling, and the second value being configured for representing the non-first sampling; and determining a feature obtained by a last sampling in the target sampling count as the second image feature.

By way of example, the first value for representing the first sampling is 1, the non-first sampling is an N^{th} sampling, and the second value for representing the non-first sampling is N. N is an integer greater than 1. For example, if the non-first sampling is a third sampling, the second value is 3.

The process of obtaining a first text noise feature and a first image noise feature according to the target text feature, the first image feature, and a first value includes: obtaining the first text noise feature and the first image noise feature according to the target text feature, the first image feature, the first value, and a diffuse map model.

Before obtaining the first text noise feature and the first image noise feature according to the target text feature, the first image feature, the first value, and a diffuse map model, the diffuse map model may be first obtained. The process of obtaining the diffuse map model includes: obtaining a sample picture and text corresponding to the sample picture; inputting the sample picture and the text corresponding to the sample picture into an initial diffuse map model; repeatedly performing noise addition to the sample picture by using the initial diffuse map model, and recording a noise feature added each time noise addition is performed on the sample picture; and finally, correspondingly storing the sample picture, the text corresponding to the sample picture, and the noise feature added each time noise addition is performed on the sample picture in the initial diffuse map model, to obtain the diffuse map model. The sample picture, the text corresponding to the sample picture, and the noise feature added each time noise addition is performed on the sample picture are stored in the diffuse map model.

The initial diffuse map model may be a denoising diffusion probabilistic model (DDPM).

FIG. 6 is a diagram of a process of obtaining a diffuse map model according to some embodiments. In FIG. 6, a sample picture and text (A cat in the snow) corresponding to the sample picture are input into an initial diffuse map model. By means of repeated noise addition, a noise feature added during each noise addition and a picture after each noise addition are obtained. The sample picture, the text corresponding to the sample picture, and the noise feature added each time noise addition is performed on the sample picture are stored in an initial diffuse map model, to further obtain a diffuse map model.

In some embodiments, the process of obtaining the first text noise feature and the first image noise feature according to the target text feature, the first image feature, the first value, and a diffuse map model includes: using a noise feature added when noise addition is performed for the first value on a sample picture corresponding to a first text in the diffuse map model as the first text noise feature, and using a noise feature added when noise addition is performed for the first value on a first picture in the diffuse map model as the first image noise feature. The first text is text for which a matching degree between a corresponding text feature and the target text feature satisfies a matching requirement. The first picture is a sample picture for which a matching degree between a corresponding image feature and the first image feature satisfies a matching requirement. Satisfying the matching requirement may mean that the matching degree is the maximum or otherwise meets a preset threshold. However, the disclosure is not limited thereto.

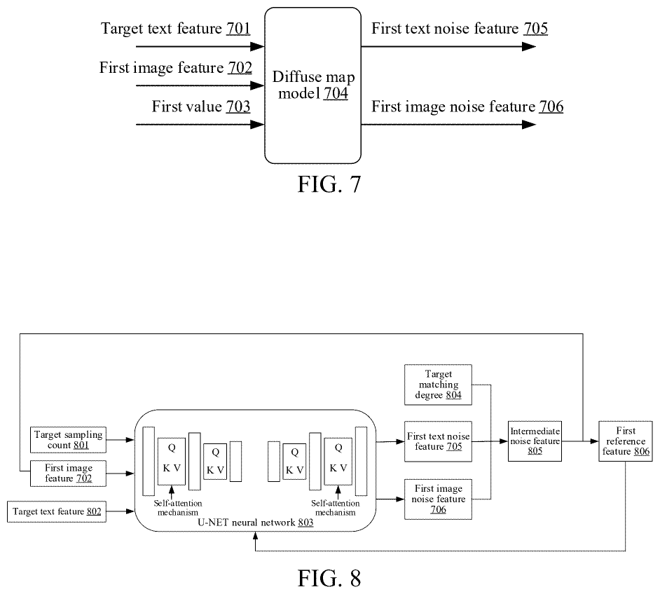

FIG. 7 is a diagram of a process of obtaining a first text noise feature and a first image noise feature according to some embodiments. In FIG. 7, a target text feature 701, a first image feature 702, and a first value 703 are input into a diffuse map model 704. A first text noise feature 705 and a first image noise feature 706 are obtained by using the diffuse map model 704.

By way of example, the diffuse map model stores sample picture 1, text 1corresponding to sample picture 1, noise feature 1, noise feature 2, and noise feature 3respectively added when three noise additions are performed on sample picture 1, sample picture 2, text 2 corresponding to sample picture 2, and noise feature 4, noise feature 5, and noise feature 6 respectively added when three noise additions are performed on sample picture 2. If text having a maximum matching degree with the target text feature is text 1, noise feature 1 added when the first noise addition is performed on sample picture 1 corresponding to text 1 is used as a first text noise feature. If a sample picture having a maximum matching degree with the first image feature is sample picture 2, noise feature 4 added when the first noise addition is performed on sample picture 2 is used as a first image noise feature.

After the first text noise feature and the first image noise feature are obtained, the process of determining a first reference feature according to the first text noise feature, the first image noise feature, the target matching degree, and the first image feature includes: determining an intermediate noise feature according to the first text noise feature, the first image noise feature, and the target matching degree; and determining the first reference feature according to the intermediate noise feature and the first image feature.

In some embodiments, the process of determining an intermediate noise feature according to the first text noise feature, the first image noise feature, and the target matching degree includes: determining a difference between the first text noise feature and the first image noise feature; determining a product of the difference and the target matching degree; and finally, using a sum of the product and the first image noise feature as the intermediate noise feature. The process of determining the first reference feature according to the intermediate noise feature and the first image feature includes: using a difference between the first image feature and the intermediate noise feature as the first reference feature.

By way of example, the intermediate noise feature may be determined according to the first text noise feature, the first image noise feature, and the target matching degree, based on the following formula (1):

$$W = ( X - Y ) \times Z + Y \qquad Formula ( 1 )$$

In the foregoing formula (1), W is the intermediate noise feature, X is the first text noise feature, Y is the first image noise feature, and Z is the target matching degree.

According to the intermediate noise feature and the first image feature, the first reference feature may be determined based on the following formula (2):

$$H = F - W \qquad Formula ( 2 )$$

In the foregoing formula (2), H is the first reference feature, F is the first image feature, and W is the intermediate noise feature.

In some embodiments, the process of obtaining a second text noise feature and a second image noise feature according to the target text feature, the reference feature, and a second value is similar to the foregoing process of obtaining a first text noise feature and a first image noise feature according to the target text feature, the first image feature, and a first value. The process of determining a second reference feature according to the second text noise feature, the second image noise feature, the target matching degree, and the reference feature is similar to the foregoing process of determining a first reference feature according to the first text noise feature, the first image noise feature, the target matching degree, and the first image feature.

By way of example, the target sampling count is 3, and the target matching degree is 0.4. Text noise feature 1 and image noise feature 1 are obtained according to the target text feature, the first image feature, and 1. Reference feature 1 is determined according to text noise feature 1, image noise feature 1, 0.4, and the first image feature. Text noise feature 2 and image noise feature 2 are obtained according to the target text feature and reference feature 1. Reference feature 2 is determined according to text noise feature 2, image noise feature 2, 0.4, and reference feature 1. Text noise feature 3 and image noise feature 3 are obtained according to the target text feature and reference feature 2. Reference feature 3 is determined according to text noise feature 3, image noise feature 3, 0.4, and reference feature 2. Three sampling processes have now been performed. Reference feature 3 is used as the second image feature.

FIG. 8 is a diagram of a process of obtaining a second image feature according to some embodiments. In FIG. 8, a target sampling count 801, a first image feature 702, and a target text feature 802 are input into a U-NET neural network 803 (a network for generating a garment), to obtain a first text noise feature 705 and a first image noise feature 706. An intermediate noise feature 805 is determined according to a target matching degree 804, the first text noise feature 705, and the first image noise feature 706. A first reference feature 806 is determined according to the intermediate noise feature 805 and the first image feature 702. The first reference feature 806 is input into the U-NET neural network 803 to continue to perform sampling until a feature obtained by a last sampling is obtained. The feature obtained by the last sampling is used as a second image feature. A diffuse map model is embedded in the U-NET neural network.

After the second image feature is obtained, the process of decoding the second image feature, to obtain the second diffuse map includes: decoding the second image feature, to obtain a pixel map corresponding to the second image feature; and generating the second diffuse map according to the pixel map corresponding to the second image feature. The second image feature is decoded by using a VAE, to obtain a pixel map corresponding to the second image feature. The pixel map corresponding to the second image feature is returned to a file generation server. The second diffuse map is generated by using the file generation server. The file generation server and the foregoing garment information server may be one server, or may be different servers. However, the disclosure is not limited thereto.

In some embodiments, a normal map model and a material map model are further embedded in the U-NET neural network. The process of obtaining a normal map model and a material map model is similar to the foregoing process of obtaining a diffuse map model. The original garment information includes a first normal map, and the target garment information includes a second normal map. The process of obtaining a second normal map by sampling for the target sampling count according to the first keyword, the second keyword, the target matching degree, and the first normal map is similar to the foregoing process of obtaining a second diffuse map by sampling based on the target sampling count according to the first keyword, the second keyword, the target matching degree, and the first diffuse map. The original garment information includes a first material map, and the target garment information includes a second material map. The process of obtaining a second material map by sampling for the target sampling count according to the first keyword, the second keyword, the target matching degree, and the first material map is similar to the foregoing process of obtaining a second diffuse map by sampling based on the target sampling count according to the first keyword, the second keyword, the target matching degree, and the first diffuse map in some embodiments.

The terminal device further stores a garment model. After target garment information of the target garment is obtained, the process of generating the target garment according to the target garment information includes: mapping the target garment information to the garment model, to obtain the target garment. The target garment information includes a second diffuse map, a second normal map, and a second material map. The second diffuse map, the second normal map, and the second material map are respectively mapped to the garment model, to obtain the target garment.

In some embodiments, after the target garment is generated, the target garment may further be displayed on the game page. The process of displaying the target garment on the game page includes: canceling displaying of the original garment displayed on the game page, and displaying the target garment on the game page.

When the original garment is displayed on the game page, the virtual object displayed on the game page wears the original garment. After the target garment is generated, the process of displaying the target garment on the game page includes: replacing a garment (the original garment), worn by the virtual object on the game page, with the target garment, to display the target garment on the game page.

According to the game interaction method provided in some embodiments, a target garment of a virtual object is generated by using an AI technology. The method may be widely applied to at least the following several scenes: (1) Game Development: During a game production process, the game interaction method provided in some embodiments may assist a designer in rapidly generating target garments of a plurality of styles, thereby improving design efficiency. This technology is useful for a game that needs a large quantity of characters. According to the game interaction method provided in some embodiments, garment styles and elements may further be automatically adjusted according to settings of a game world and background stories of characters, to ensure consistency and accuracy of design. (2) Personalized Customization: A player may customize a unique garment according to a favored style of the player or characteristics of a game character by using the game interaction method provided in some embodiments. Such a personalized service can improve gaming experience of the player and personalization of the character. (3) Virtual Try-on: The game interaction method provided in some embodiments may implement a try-on function of a virtual character in a game, and a player may preview an effect of a garment on the character before purchasing the garment, thereby improving purchase satisfaction of the garment and reducing a return rate. (4) Cross-platform Content Creation: A content creator may rapidly create a garment design related to a game character on different platforms by using the game interaction method provided in some embodiments, including fields such as social media, 3D printing, and virtual reality. (5) Cultural Inheritance and Innovation: The game interaction method provided in some embodiments may innovatively design a garment for a game character based on respect and protection of traditional culture. Traditional elements may be blended with modern design, promoting and preserving outstanding traditional culture. (6) Marketing and Promotion: In marketing campaigns, game companies may utilize garment designs generated by the game interaction method provided in some embodiments to attract players, for example, by hosting garment design competitions, thereby enhancing player engagement and raising the game's visibility. (7) Education and Training: During education and training of game design and development, the technology for generating a garment by using the game interaction method provided in some embodiments may be used as a tool to assist students in better understanding character design and construction of a game world. (8) Prototype Testing: In the early stages of game development, the game interaction method provided in some embodiments may rapidly generate various garment prototypes for designers and testers to evaluate and provide feedback, accelerating the game development progress.

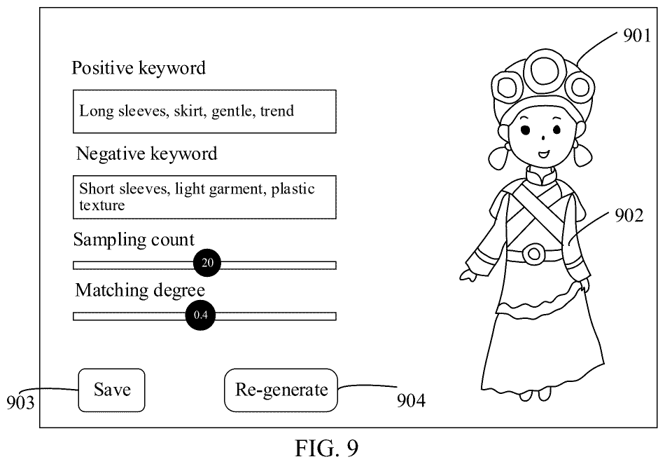

FIG. 9 is a schematic diagram of display of another game page according to some embodiments. A virtual object 901 shown in FIG. 9 wears a target garment 902.

In some embodiments, after a target garment is generated, display of the generation control on the game page is canceled, and a save control and a re-generation control are displayed on the game page. The save control is configured to save the target garment. The re-generation control is configured to, after at least one of a first keyword, a second keyword, a target sampling count, and a target matching degree is modified, regenerate a garment according to the modified information. The process of regenerating a garment is similar to the process of generating a target garment. Reference numeral 903 in FIG. 9 denotes the save control, and reference numeral 904 denotes the re-generation control.

In some embodiments, after the target garment is saved, the process of performing game interaction based on the target garment includes any one of the following: controlling a virtual object wearing the target garment to play a game; selling the target garment; and participating in an appraisal activity of the game based on the target garment.

If the target garment is sold, the game object may obtain game resources, so that the game object can purchase other virtual items in the game. Based on participation of the target garment in the appraisal activity of the game, if the number of votes of support received for the target garment meets a vote requirement, the game object may obtain a reward resource corresponding to the vote requirement. That the number of votes of support meets a vote requirement may mean that the number of votes of support ranks and a reward resource corresponding to the first rank may be obtained.

In some embodiments, in a case that the virtual object displayed on the game page wears an original garment, a garment page is displayed in response to a trigger operation for the virtual object. The garment page displays at least one alternative garment. In response to a trigger operation for any one of the at least one alternative garment, the garment (the original garment) worn by the virtual object displayed on the game page is replaced with the selected alternative garment. Garment information of the selected alternative garment is obtained in response to a trigger operation for a generation function, and a new garment is generated by sampling based on a target sampling count according to the garment information of the selected alternative garment, a first keyword, a second keyword, and a target matching degree.

The garment information of any garment includes at least one of a diffuse map of any garment, a normal map of any garment, or a material map of any garment. The diffuse map of any garment is configured for indicating a style and a color of any garment. The normal map of any garment is configured for indicating a visual effect of any garment. The material map of any garment is configured for indicating a material of any garment. The process of generating a new garment by sampling based on a target sampling count according to the garment information of any garment, a first keyword, a second keyword, and a target matching degree is similar to the foregoing process of generating the target garment by sampling based on the target sampling count according to the first keyword, the second keyword, the target matching degree, and the original garment information.

According to the foregoing method, after obtaining a first keyword and original garment information of an original garment, a target garment generated according to the original garment information and matching the first keyword is displayed. The method improves flexibility and diversity of generating the target garment. The first keyword can correctly express a preference of a player, and the generated target garment matches the first keyword. The generated target garment is a garment matching the player, so that the generated garment better conforms to a requirement of the player, and highly matches the player. The player not only may select a garment provided in a game, but also may generate a garment voluntarily, thereby expanding a range of selecting a garment by the player, and further improving game experience of the player. The player may perform game interaction based on the target garment, thereby improving diversity and flexibility of game interaction.

The player generates a new garment in a manner of voluntarily generating a garment. A game developer may not design more garments, thereby saving art manufacturing costs and periods of the game developer and reducing costs of game development.

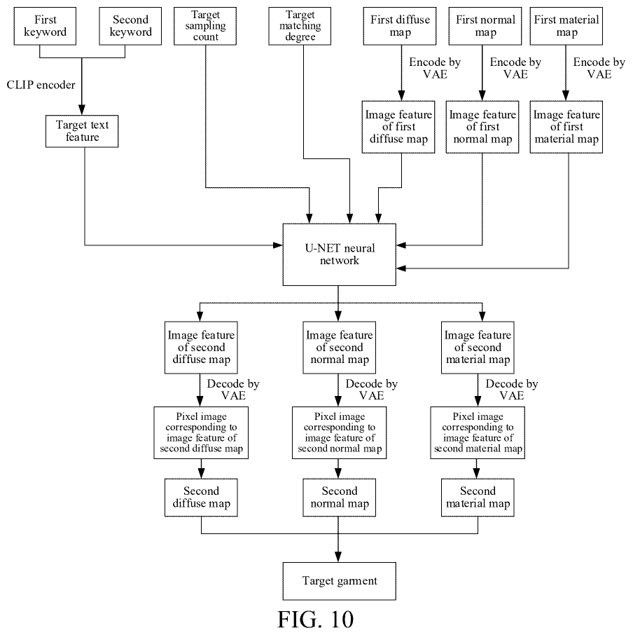

FIG. 10 is a flowchart of a game interaction method according to some embodiments. As shown in FIG. 10, the procedure includes: obtaining a first keyword, a second keyword, a target sampling count, a target matching degree, and a first diffuse map, a first normal map, and a first material map of an original garment. The first keyword and the second keyword are processed by using a CLIP encoder to obtain a target text feature. The first diffuse map is encoded by using a VAE to obtain an image feature of the first diffuse map. The first normal map is encoded by using the VAE to obtain an image feature of the first normal map. The first material map is encoded by using the VAE to obtain an image feature of the first material map. The target text feature, the target sampling count, the target matching degree, and the image feature of the first diffuse map are input into a U-NET neural network to obtain an image feature of a second diffuse map. The target text feature, the target sampling count, the target matching degree, and the image feature of the first normal map are input into the U-NET neural network to obtain an image feature of a second normal map. The target text feature, the target sampling count, the target matching degree, and the image feature of the first material map are input into the U-NET neural network to obtain an image feature of a second material map. The image feature of the second diffuse map is decoded by using the VAE to obtain a pixel map corresponding to the image feature of the second diffuse map. The image feature of the second normal map is decoded by using the VAE to obtain a pixel map corresponding to the image feature of the second normal map. The image feature of the second material map is decoded by using the VAE to obtain a pixel map corresponding to the image feature of the second material map. The second diffuse map is obtained according to the pixel map corresponding to the image feature of the second diffuse map. The second normal map is obtained according to the pixel map corresponding to the image feature of the second normal map. The second material map is obtained according to the pixel map corresponding to the image feature of the second material map. A target garment is generated according to the second diffuse map, the second normal map, and the second material map.

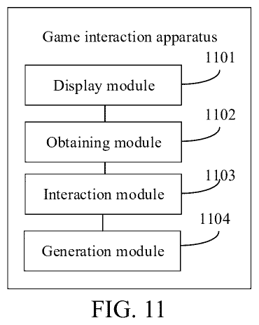

FIG. 11 shows a schematic structural diagram of a game interaction apparatus according to some embodiments. As shown in FIG. 11, the apparatus includes:
a display module 1101, configured to display a game page, an original garment being displayed on the game page; an obtaining module 1102, configured to obtain a first keyword and original garment information of the original garment in response to a first trigger operation for a generation function, the original garment information including at least one of a first diffuse map, a first normal map, and a first material map, the first diffuse map being configured for indicating a style and a color of the original garment, the first normal map being configured for indicating a visual effect of the original garment, and the first material map being configured for indicating a material of the original garment; the display module 1101, further configured to display a target garment generated based on the original garment information and matching the first keyword; and an interaction module 1103, configured to perform game interaction based on the target garment.

In some embodiments, a virtual object is further displayed on the game page, and the virtual object wears the original garment. The display module 1101 is further configured to replace a garment (the original garment), worn by the virtual object displayed on the game page, with the target garment.

In some embodiments, the interaction module 1103 is further configured to perform at least one of the following: controlling the virtual object wearing the target garment to play a game; selling the target garment; and participating in an appraisal activity of the game based on the target garment.

In some embodiments, the obtaining module 1102 is further configured to obtain a second keyword, a target sampling count, and a target matching degree in response to a second trigger operation for the generation function, the second keyword being a keyword not matching the target garment, the target sampling count being a count of repetitions of a sampling process of obtaining target garment information of the target garment, the target matching degree being a matching degree between the target garment and the first keyword, the target garment information including at least one of a second diffuse map, a second normal map, and a second material map, the second diffuse map being configured for indicating a style and a color of the target garment, the second normal map being configured for indicating a visual effect of the target garment, and the second material map being configured for indicating a material of the target garment. A generation module 1104 is configured to generate the target garment by sampling based on the target sampling count according to the first keyword, the second keyword, the target matching degree, and the original garment information, the matching degree between the target garment and the first keyword being the target matching degree, and the target garment not matching the second keyword.

In some embodiments, the generation module 1104 is further configured to: obtain target garment information of the target garment by sampling based on the target sampling count according to the first keyword, the second keyword, the target matching degree, and the original garment information; and generate the target garment according to the target garment information.

In some embodiments, the original garment information includes the first diffuse map, and the target garment information includes the second diffuse map. The generation module 1104 is further configured to: obtain a target text feature according to the first keyword and the second keyword, the target text feature being configured for representing the first keyword and the second keyword; obtain a first image feature according to the first diffuse map, the first image feature being configured for representing the first diffuse map; obtain a second image feature by sampling based on the target sampling count according to the target text feature, the first image feature, and the target matching degree, the second image feature being configured for representing the second diffuse map; and decode the second image feature, to obtain the second diffuse map.

In some embodiments, the generation module 1104 is further configured to: obtain a first text noise feature and a first image noise feature according to the target text feature, the first image feature, and a first value for a first sampling in the target sampling count; determine a first reference feature according to the first text noise feature, the first image noise feature, the target matching degree, and the first image feature, the first reference feature being a feature obtained by denoising the first image feature during the first sampling, the first text noise feature matching the target text feature, the first image noise feature matching the first image feature, and the first value being configured for representing the first sampling; obtain a second text noise feature and a second image noise feature according to the target text feature, the reference feature, and a second value for a non-first sampling in the target sampling count; determine a second reference feature according to the second text noise feature, the second image noise feature, the target matching degree, and the reference feature, the second reference feature being a feature obtained by denoising the reference feature during the non-first sampling, the second text noise feature matching the target text feature, the second image noise feature matching the reference feature, the reference feature being a feature obtained by a previous sampling to the non-first sampling, and the second value being configured for representing the non-first sampling; and determine a feature obtained by a last sampling in the target sampling count as the second image feature.

In some embodiments, the generation module 1104 is further configured to: determine an intermediate noise feature according to the first text noise feature, the first image noise feature, and the target matching degree; and determine the first reference feature according to the intermediate noise feature and the first image feature.

In some embodiments, the generation module 1104 is further configured to: obtain a first text feature for representing the first keyword; obtain a second text feature for representing the second keyword; and determine the target text feature according to the first text feature and the second text feature.

In some embodiments, the first text feature and the second text feature have a same dimensionality. The generation module 1104 is further configured to add values of the first text feature and the second text feature at corresponding positions, to obtain the target text feature.

In some embodiments, the first text feature and the second text feature have a same dimensionality. The generation module 1104 is further configured to multiply values of the first text feature and the second text feature at corresponding positions, to obtain the target text feature.

In some embodiments, the generation module 1104 is further configured to: decode the second image feature, to obtain a pixel map corresponding to the second image feature; and generate the second diffuse map according to the pixel map corresponding to the second image feature.

The foregoing apparatus displays, after obtaining a first keyword and original garment information of an original garment, a target garment generated according to the original garment information and matching the first keyword. The method implemented by the apparatus improves flexibility and diversity of generating the target garment. The first keyword can correctly express a preference of a player, and the generated target garment matches the first keyword. The generated target garment is a garment matching the player, so that the generated garment better conforms to a requirement of the player, and highly matches the player. The player not only may select a garment provided in a game, but also may generate a garment voluntarily, thereby expanding a range of selecting a garment by the player, and further improving game experience of the player. The player may perform game interaction based on the target garment, thereby improving diversity and flexibility of game interaction.

The player generates a new garment in a manner of voluntarily generating a garment. A game developer may not design more garments, thereby saving art manufacturing costs and periods of the game developer and reducing costs of game development.

When the apparatus provided above implements the functions of the apparatus, only division into the foregoing function modules is used as an example for description. In the practical application, the functions may be allocated to and completed by different function modules according to requirements. An internal structure of the device is divided into different function modules to complete all or some of the functions described above. The apparatus provided in some embodiments belongs to the same idea as the method embodiment. For an implementation process thereof, refer to the method embodiment.

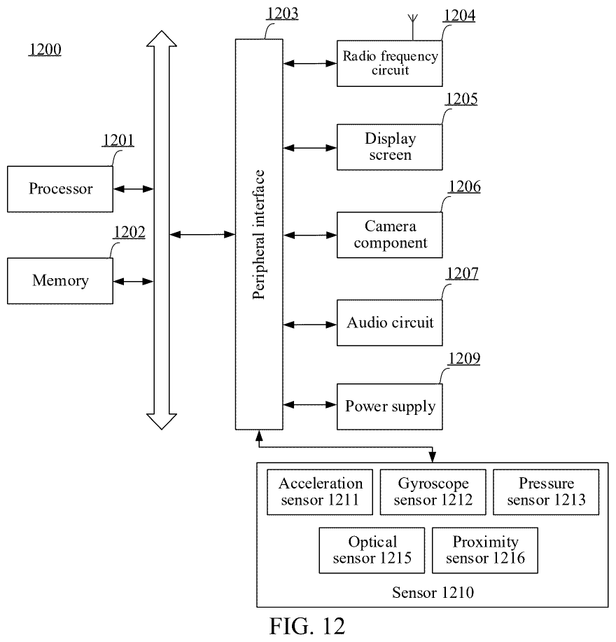

FIG. 12 shows a structural block diagram of a terminal device 1200 according to some embodiments. The terminal device 1200 may be any electronic device product that may perform human-computer interaction with a user in one or more manners such as a keyboard, a touchpad, a remote control, voice interaction, or a handwriting device, for example, a PC, a mobile phone, a smartphone, a PDA, a wearable device, a PPC, a tablet computer, a smart on-board unit, a smart television, a smart speaker, or a smartwatch.

The terminal device 1200 includes a processor 1201 and a memory 1202.

The processor 1201 may include one or more processing cores, and may be, for example, a four-core processor or an eight-core processor. The processor 1201 may be implemented by using at least one hardware form of a digital signal processing (DSP), a field-programmable gate array (FPGA), and a programmable logic array (PLA). The processor 1201 may further include a main processor and a coprocessor. The main processor is a processor for processing data in an awake state, and is referred to as a central processing unit (CPU). The coprocessor is a low-power processor for processing the data in a standby state. In some embodiments, the processor 1201 may be integrated with a graphics processing unit (GPU). The GPU is configured to render and draw content that may be displayed on a display screen. In some embodiments, the processor 1201 may further include an AI processor. The AI processor is configured to process computing operations correlated with machine learning.

The memory 1202 may include one or more computer-readable storage media. The computer-readable storage media may be non-transient. The memory 1202 may further include a high-speed random access memory, as well as a non-volatile memory, such as one or more disk storage devices and flash storage devices. In some embodiments, the non-transient computer-readable storage medium in the memory 1202 is configured to store at least one computer instruction. The at least one computer instruction is configured for being executed by the processor 1201 to implement the game interaction method provided in the method embodiment of this application.

In some embodiments, the terminal device 1200 may include: a peripheral interface 1203 and at least one peripheral. The processor 1201, the memory 1202, and the peripheral interface 1203 may be connected by using a bus or a signal wire. Each peripheral may be connected to the peripheral interface 1203 by using a bus, a signal wire, or a circuit board. The peripheral includes: at least one of a radio frequency (RF) circuit 1204, a display screen 1205, a camera component 1206, an audio circuit 1207, and a power supply 1209.

The peripheral interface 1203 may be configured to connect at least one peripheral related to input/output (I/O) to the processor 1201 and the memory 1202. In some embodiments, the processor 1201, the memory 1202, and the peripheral interface 1203 are integrated on the same chip or circuit board. In some embodiments, any one or two of the processor 1201, the memory 1202, and the peripheral interface 1203 may be implemented on a single chip or circuit board, which is not limited.

The RF circuit 1204 is configured to receive and transmit an RF signal, referred to as an electromagnetic signal. The RF circuit 1204 communicates with a communication network and another communication device by using the electromagnetic signal. The RF circuit 1204 converts an electrical signal into an electromagnetic signal for transmission, or converts a received electromagnetic signal into an electrical signal. The RF circuit 1204 includes: an antenna system, an RF transceiver, one or more amplifiers, a tuner, an oscillator, a digital signal processor, a coder and decoder chip set, a subscriber identity module card, and the like. The RF circuit 1204 may communicate with another terminal device by using at least one wireless communication protocol. The wireless communication protocol includes, but is not limited to, generations of mobile communication networks (2G, 3G, 4G, and 5G), a wireless local area network, and/or a wireless fidelity (Wi-Fi) network. In some embodiments, the RF circuit 1204 may further include a circuit related to near field communication (NFC). However, the disclosure is not limited thereto.

The display screen 1205 is configured to display a user interface (UI). The UI may include a graph, text, an icon, a video, and any combination thereof. When the display screen 1205 is a touchscreen, the display screen 1205 further has a capability of acquiring a touch signal on or above a surface of the display screen 1205. The touch signal may be input to the processor 1201 as a control signal for processing. The display screen 1205 may be further configured to provide at least one of a virtual button and a virtual keyboard, referred to as at least one of a soft button and a soft keyboard. In some embodiments, there may be one display screen 1205, disposed on a front panel of the terminal device 1200. In some embodiments, there may be at least two display screens 1205, respectively disposed on different surfaces of the terminal device 1200 or in a folded design. In some embodiments, the display screen 1205 may be a flexible display screen, disposed on a curved surface or a folded surface of the terminal device 1200. In some embodiments, the display screen 1205 may even be disposed in a non-rectangular irregular pattern, for example, a special-shaped screen. The display screen 1205 may be made of a liquid crystal display (LCD), an organic light-emitting diode (OLED), or other materials.

The camera component 1206 is configured to acquire images or videos. The camera component 1206 includes a front-facing camera and a rear-facing camera. The front-facing camera is disposed on the front panel of the terminal device 1200, and the rear-facing camera is disposed on a back surface of the terminal device 1200. In some embodiments, there are at least two rear-facing cameras, which are any one of a main camera, a depth-of-field camera, a wide-angle camera, and a telephoto camera, respectively. The main camera and the depth-of-field camera are combined to realize a bokeh function. The main camera and the wide-angle camera are combined to realize a panorama function, a virtual reality (VR) shooting function, or other combined shooting functions. In some embodiments, the camera component 1206 may further include a flash. The flash may be a single-color-temperature flash or a dual-color-temperature flash. The dual-color-temperature flash refers to a combination of a warm light flash and a cold light flash, and may be configured for light compensation under different color temperatures.

The audio circuit 1207 may include a microphone and a speaker. The microphone is configured to acquire sound waves of a user and an environment, and convert the sound waves into an electrical signal to be input to the processor 1201 for processing, or input to the RF circuit 1204 for implementing voice communication. For the purpose of stereo acquisition or noise reduction, there may be a plurality of microphones provided at different portions of the terminal device 1200. The microphone may be an array microphone or an omnidirectional microphone. The speaker is configured to convert an electrical signal from the processor 1201 or the RF circuit 1204 into sound waves. The speaker may be a film speaker or a piezoelectric ceramic speaker. When the speaker is a piezoelectric ceramic speaker, the speaker not only may convert an electrical signal into a sound wave audible to a human being, but also may convert an electrical signal into a sound wave inaudible to a human being, for ranging and other purposes. In some embodiments, the audio circuit 1207 may further include a headset jack.

The power supply 1209 is configured to supply power to components in the terminal device 1200. The power supply 1209 may be alternating current, direct current, a primary battery, or a rechargeable battery. When the power supply 1209 includes a rechargeable battery, the rechargeable battery may be a wired rechargeable battery or a wireless rechargeable battery. The wired rechargeable battery is a battery charged by using a wired circuit, and the wireless rechargeable battery is a battery charged by using a wireless coil. The rechargeable battery may further be configured to support a fast charging technology.

In some embodiments, the terminal device 1200 further includes one or more sensors 1210. The one or more sensors 1210 include, but are not limited to, an acceleration sensor 1211, a gyroscope sensor 1212, a pressure sensor 1213, an optical sensor 1215, and a proximity sensor 1216.

The acceleration sensor 1211 may detect magnitudes of accelerations on three coordinate axes of a coordinate system established with the terminal device 1200. For example, the acceleration sensor 1211 may be configured to detect components of gravity acceleration on the three coordinate axes. The processor 1201 may control, according to a gravity acceleration signal acquired by the acceleration sensor 1211, the display screen 1205 to display the UI in a landscape view or a portrait view. The acceleration sensor 1211 may further be configured to acquire motion data of a game or a user.

The gyroscope sensor 1212 may detect a body direction and a rotation angle of the terminal device 1200. The gyroscope sensor 1212 may cooperate with the acceleration sensor 1211 to acquire a 3D action by the user on the terminal device 1200. The processor 1201 may implement the following functions according to the data acquired by the gyroscope sensor 1212: motion sensing (e.g., changing the UI according to a tilt operation of the user), image stabilization at shooting, game control, and inertial navigation.

The pressure sensor 1213 may be disposed at a side frame of the terminal device 1200 and/or a lower layer of the display screen 1205. When the pressure sensor 1213 is disposed at the side frame of the terminal device 1200, a holding signal of the user on the terminal device 1200 may be detected. The processor 1201 performs left and right hand recognition or a quick operation according to the holding signal acquired by the pressure sensor 1213. When the pressure sensor 1213 is disposed at the lower layer of the display screen 1205, the processor 1201 controls an operable control on the UI according to a pressure operation of the user on the display screen 1205. The operable control includes at least one of a button control, a scroll bar control, an icon control, and a menu control.

The optical sensor 1215 is configured to acquire an ambient light intensity. In some embodiments, the processor 1201 may control display brightness of the display screen 1205 according to the ambient light intensity acquired by the optical sensor 1215. When the ambient light intensity is relatively high, the display brightness of the display screen 1205 is increased. When the ambient light intensity is relatively low, the display brightness of the display screen 1205 is decreased. In some embodiments, the processor 1201 may further dynamically adjust a shooting parameter of the camera component 1206 according to the ambient light intensity acquired by the optical sensor 1215.

The proximity sensor 1216, also referred to as a distance sensor, may be provided on the front panel of the terminal device 1200. The proximity sensor 1216 is configured to acquire a distance between the user and a front surface of the terminal device 1200. In some embodiments, when the proximity sensor 1216 detects that a distance between the user and the front surface of the terminal device 1200 gradually decreases, the display screen 1205 is controlled by the processor 1201 to switch from a screen-on state to a screen-off state. When the proximity sensor 1216 detects that the distance between the user and the front surface of the terminal device 1200 gradually increases, the display screen 1205 is controlled by the processor 1201 to switch from a screen-off state to a screen-on state.

The structure shown in FIG. 12 constitutes no limitation on the terminal device 1200, and the terminal device may include more or fewer components than those shown in the figure, or some components may be combined, or a different component deployment may be used.

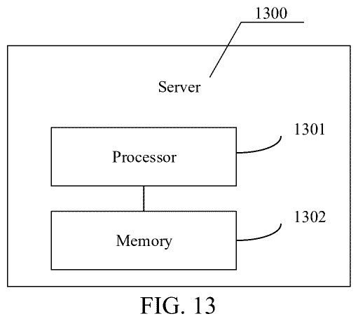

FIG. 13 is a schematic structural diagram of a server according to some embodiments. The server 1300 may vary a lot due to different configurations or performance, and may include one or more CPUs 1301 and one or more memories 1302. The one or more memories 1302 store at least one program code, and the at least one program code is loaded and executed by the one or more CPUs 1301 to implement the game interaction method provided in some embodiments. The server 1300 may further have components such as a wired or wireless network interface, a keyboard, and an input/output interface. The server 1300 may further include other components configured to implement device functions.

In some embodiments, a computer-readable storage medium is further provided. The computer-readable storage medium has at least one computer instruction stored therein. The at least one computer instruction is loaded and executed by a processor, to enable a computer device to implement the game interaction method according to any one of the foregoing aspects.

The computer-readable storage medium may be a read-only memory (ROM), a random access memory (RAM), a compact disc read-only memory (CD-ROM), a magnetic tape, a floppy disk, an optical data storage device, or the like.

In some embodiments, a computer program product is further provided. The computer program product has at least one computer instruction stored therein. The at least one computer instruction is loaded and executed by a processor, to enable a computer device to implement the game interaction method according to any one of the foregoing aspects.

Information (including but not limited to user equipment information, user personal information, and the like), data (including but not limited to data for analysis, data for storage, data for display, and the like), and signals involved in some embodiments are all authorized by users or fully authorized by all parties, and collection, use, and processing of relevant data should comply with relevant laws, regulations, and standards of relevant regions. For example, garment information involved in some embodiments is all obtained under full authorization.

The sequence numbers of some embodiments are for description purpose but do not indicate the preference of some embodiments.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A game interaction method, performed by a computer device, the method comprising:
displaying a game page comprising a depiction of an original garment;
obtaining a first keyword and original garment information of the original garment in response to a first trigger operation for a generation function, the original garment information comprising at least one of a first diffuse map, a first normal map, and a first material map, wherein the first diffuse map indicates a style and a color of the original garment, the first normal map indicates a visual effect of the original garment, and the first material map indicates a material of the original garment;
generating a target garment, based on the original garment information, that matches the first keyword, and displaying the target garment; and
including the target garment in a game interaction.

2. The game interaction method according to claim 1, wherein the game page comprises a depiction of a virtual object that is wearing the original garment, and
wherein the displaying the target garment comprises replacing the depiction of the virtual object that is wearing the original garment with a depiction of the virtual object wearing the target garment.

3. The game interaction method according to claim 1, wherein the game interaction comprises at least one of: controlling the virtual object in a game, and the virtual object is depicted as wearing the target garment; selling or trading the target garment; and including the target garment in an appraisal activity of the game.

4. The game interaction method according to claim 1, further comprising:
obtaining a second keyword, a target sampling count, and a target matching degree in response to a second trigger operation for the generation function, wherein:
the second keyword does not match the target garment,
the target sampling count indicates a number of repetitions of a sampling process for obtaining target garment information of the target garment,
the target matching degree indicates a degree to which the target garment and the first keyword correspond,
the target garment information comprises at least one of a second diffuse map, a second normal map, and a second material map,
the second diffuse map indicates a style and a color of the target garment,
the second normal map indicates a visual effect of the target garment, and
the second material map indicates a material of the target garment, and
wherein before displaying the target garment, the method further comprises generating the target garment by performing the sampling process a number of times that is based on the target sampling count, the target garment being generated to achieve the target matching degree with respect to the first keyword and without achieving the target matching degree with respect to the second keyword, wherein the sampling process is performed based on the first keyword, the second keyword, the target matching degree, and the original garment information.

5. The game interaction method according to claim 4, wherein the generating the target garment by performing the sampling process comprises:
obtaining target garment information of the target garment by performing the sampling process a number of times that is based on the target sampling count, based on the first keyword, the second keyword, the target matching degree, and the original garment information; and
generating the target garment based on the target garment information.

6. The game interaction method according to claim 5, wherein the original garment information comprises the first diffuse map, and the target garment information comprises the second diffuse map, and
wherein the obtaining the target garment information comprises:
obtaining a target text feature based on the first keyword and the second keyword, the target text feature representing the first keyword and the second keyword;
obtaining a first image feature based on the first diffuse map, the first image feature representing the first diffuse map;
obtaining a second image feature by performing the sampling process a number of times that is based on the target sampling count, based on the target text feature, the first image feature, and the target matching degree, the second image feature representing the second diffuse map; and
obtaining the second diffuse map by decoding the second image feature.

7. The game interaction method according to claim 6, wherein the obtaining the second image feature comprises:
obtaining a first text noise feature and a first image noise feature based on the target text feature, the first image feature, and a first value representing a first sampling from among the number of times that the sampling process is performed, and
determining a first reference feature based on the first text noise feature, the first image noise feature, the target matching degree, and the first image feature, the first reference feature being obtained by denoising the first image feature in the first sampling, the first text noise feature matching the target text feature, and the first image noise feature matching the first image feature;
obtaining a second text noise feature and a second image noise feature based on the target text feature, the first reference feature, and a second value representing a subsequent sampling from among the number of times that the sampling process is performed;
determining a second reference feature based on the second text noise feature, the second image noise feature, the target matching degree, and the first reference feature, the second reference feature being obtained by denoising the first reference feature during the subsequent sampling, the second text noise feature matching the target text feature, and the second image noise feature matching the first reference feature; and
determining a feature obtained by a last sampling, from among the number of times that the sampling process is performed, as the second image feature.

8. The game interaction method according to claim 7, wherein the determining the first reference feature comprises:
determining an intermediate noise feature based on the first text noise feature, the first image noise feature, and the target matching degree; and
determining the first reference feature based on the intermediate noise feature and the first image feature.

9. The game interaction method according to claim 6, wherein the obtaining the target text feature comprises:
obtaining a first text feature representing the first keyword;
obtaining a second text feature representing the second keyword; and
determining the target text feature based on the first text feature and the second text feature.

10. The game interaction method according to claim 9, wherein the first text feature and the second text feature have a same dimensionality, and
wherein the target text feature is determined by adding values of the first text feature and the second text feature at corresponding positions.

11. A game interaction apparatus, comprising:
at least one memory configured to store computer program code; and
at least one processor configured to read the program code and operate as instructed by the program code, the program code comprising:
first display code configured to cause at least one of the at least one processor to display a game page comprising a depiction of an original garment;
obtaining code configured to cause at least one of the at least one processor to obtain a first keyword and original garment information of the original garment in response to a first trigger operation for a generation function, the original garment information comprising at least one of a first diffuse map, a first normal map, and a first material map, wherein the first diffuse map indicates a style and a color of the original garment, the first normal map indicates a visual effect of the original garment, and the first material map indicates a material of the original garment;
second display code configured to cause at least one of the at least one processor to generate a target garment, based on the original garment information, that matches the first keyword, and display the target garment; and
interaction code configured to cause at least one of the at least one processor to include the target garment in a game interaction.

12. The game interaction apparatus according to claim 11, wherein the game page comprises a depiction of a virtual object that is wearing the original garment, and
wherein the second display code is configured to cause at least one of the at least one processor to replace the depiction of the virtual object that is wearing the original garment with a depiction of the virtual object wearing the target garment.

13. The game interaction apparatus according to claim 11, wherein the game interaction comprises at least one of: controlling the virtual object in a game, and the virtual object is depicted as wearing the target garment; selling or trading the target garment; and including the target garment in an appraisal activity of the game.

14. The game interaction apparatus according to claim 11, wherein the program code further comprises generating code configured to cause at least one of the at least one processor to:
obtain a second keyword, a target sampling count, and a target matching degree in response to a second trigger operation for the generation function, wherein:
the second keyword does not match the target garment,
the target sampling count indicates a number of repetitions of a sampling process for obtaining target garment information of the target garment,
the target matching degree indicates a degree to which the target garment and the first keyword correspond,
the target garment information comprises at least one of a second diffuse map, a second normal map, and a second material map,
the second diffuse map indicates a style and a color of the target garment,
the second normal map indicates a visual effect of the target garment, and
the second material map indicates a material of the target garment, and
wherein the second display code is configured to cause at least one of the at least one processor to generate the target garment by performing the sampling process a number of times that is based on the target sampling count, the target garment being generated to achieve the target matching degree with respect to the first keyword and without achieving the target matching degree with respect to the second keyword, wherein the sampling process is performed based on the first keyword, the second keyword, the target matching degree, and the original garment information.

15. The game interaction apparatus according to claim 14, wherein the second display code is configured to cause at least one of the at least one processor to:
obtain target garment information of the target garment by performing the sampling process a number of times that is based on the target sampling count, based on the first keyword, the second keyword, the target matching degree, and the original garment information; and
generate the target garment based on the target garment information.

16. The game interaction apparatus according to claim 15, wherein the original garment information comprises the first diffuse map, and the target garment information comprises the second diffuse map, and
wherein the generating code is configured to cause at least one of the at least one processor to:
obtain a target text feature based on the first keyword and the second keyword, the target text feature representing the first keyword and the second keyword;
obtain a first image feature based on the first diffuse map, the first image feature representing the first diffuse map;
obtain a second image feature by performing the sampling process a number of times that is based on the target sampling count, based on the target text feature, the first image feature, and the target matching degree, the second image feature representing the second diffuse map; and
obtain the second diffuse map by decoding the second image feature.

17. The game interaction apparatus according to claim 16, wherein the generating code is configured to cause at least one of the at least one processor to:
obtain a first text noise feature and a first image noise feature based on the target text feature, the first image feature, and a first value representing a first sampling from among the number of times that the sampling process is performed, and
determine a first reference feature based on the first text noise feature, the first image noise feature, the target matching degree, and the first image feature, the first reference feature being obtained by denoising the first image feature in the first sampling, the first text noise feature matching the target text feature, and the first image noise feature matching the first image feature;
obtain a second text noise feature and a second image noise feature based on the target text feature, the first reference feature, and a second value representing a subsequent sampling from among the number of times that the sampling process is performed; and
determine a second reference feature based on the second text noise feature, the second image noise feature, the target matching degree, and the first reference feature, the second reference feature being obtained by denoising the first reference feature during the subsequent sampling, the second text noise feature matching the target text feature, and the second image noise feature matching the first reference feature; and
determine a feature obtained by a last sampling, from among the number of times that the sampling process is performed, as the second image feature.

18. The game interaction apparatus according to claim 17, wherein the generating code is configured to cause at least one of the at least one processor to:
determine an intermediate noise feature based on the first text noise feature, the first image noise feature, and the target matching degree; and
determine the first reference feature based on the intermediate noise feature and the first image feature.

19. The game interaction apparatus according to claim 16, wherein the generating code is configured to cause at least one of the at least one processor to:
obtain a first text feature representing the first keyword;
obtain a second text feature representing the second keyword; and
determine the target text feature based on the first text feature and the second text feature.

20. A non-transitory computer-readable storage medium, storing computer code which, when executed by at least one processor, causes the at least one processor to at least:
display a game page comprising a depiction of an original garment;
obtain a first keyword and original garment information of the original garment in response to a first trigger operation for a generation function, the original garment information comprising at least one of a first diffuse map, a first normal map, and a first material map, wherein the first diffuse map indicates a style and a color of the original garment, the first normal map indicates a visual effect of the original garment, and the first material map indicates a material of the original garment;
generate a target garment, based on the original garment information, that matches the first keyword, and display the target garment; and
include the target garment in a game interaction.
